(19) United States
(12) Patent Application Publication
(10) Pub. No.: US 2024/0028403 A1
(43) Pub. Date: Jan. 25, 2024

(54) SYSTEMS AND METHODS FOR JOB ASSIGNMENT BASED ON DYNAMIC CLUSTERING AND FORECASTING

(71) Applicant: Verizon Patent and Licensing Inc., Basking Ridge, NJ (US)

(72) Inventors: Subham BISWAS, Thane (IN); Keerthivasan MADURAI, Chengalpattu (IN)

(73) Assignee: Verizon Patent and Licensing Inc., Basking Ridge, NJ (US)

(21) Appl. No.: 17/872,433

(22) Filed: Jul. 25, 2022

(51) Int. Cl. G06F 9/50

(52) U.S. Cl. CPC G06F 9/5027

(57) ABSTRACT

In some implementations, a device may determine cluster arrangements of clusters of technicians to perform a job. The device may provide, as input to a model, input values corresponding to exogenous factors associated with the job and with the cluster arrangements. The device may receive, as an output from the model, forecast values corresponding to endogenous factor(s) associated with the cluster arrangements. The device may determine combined forecast values associated with the cluster arrangements. A combined forecast value associated with a particular cluster arrangement may be a combination of forecast value(s) corresponding to the endogenous factor(s) associated with the particular cluster arrangement. The device may identify a selected cluster arrangement having a lowest combined forecast value. The device may assign the job to one or more technicians associated with the selected cluster arrangement.

### BACKGROUND

Dynamic clustering is a technique that uses weights and workload management to balance the workloads of its cluster members dynamically, based on performance information. Dynamic clustering is often employed with respect to server technology. Clusters may be defined automatically via rules based on different properties. Alternatively, clusters may be defined manually.

### BRIEF DESCRIPTION OF THE DRAWINGS

FIGS. 1A-1D are diagrams of an example associated with job assignment based on dynamic clustering.

FIG. 2 is a diagram of an example environment in which systems and/or methods described herein may be implemented.

FIG. 3 is a diagram of example components of a device associated with job assignment.

FIGS. 4 and 5 are flowcharts of example processes associated with job assignment based on dynamic clustering.

### DETAILED DESCRIPTION OF EXAMPLE EMBODIMENTS

The following detailed description of example implementations refers to the accompanying drawings. The same reference numbers in different drawings may identify the same or similar elements.

An entity (e.g., a service company) may have multiple jobs to perform on a daily basis, such as addressing issues of a customer or client, service outages, equipment damage, equipment failure, and/or the like. The entity may assign technicians to perform the jobs. The jobs and technicians may be assigned based on an estimated time to complete the jobs. Such estimates are generally determined by averaging data for similar jobs across a certain historical time frame (e.g., the previous three months). However, relying solely on previous jobs, without accounting for potential external factors, often results in inaccurate estimates, which further may result in operational issues and/or inefficient use of computing resources For example, an estimate that is too short may significantly affect the scheduling of later jobs (e.g., the start time of subsequent jobs may be delayed to the point where at least one subsequent job may not be able to be performed and/or completed as originally scheduled). Accordingly, computing resources of the entity may be used to reschedule the subsequent job(s) and/or to remedy any issues that may arise from the delayed and/or incomplete job.

Additionally, or alternatively, to address issues resulting from the inaccurate estimates (e.g., potential delayed or rescheduled times of subsequent jobs), the entity may schedule different technicians to perform the subsequent jobs, which may require additional computing resources to determine which technicians are available and to assign the subsequent jobs to those technicians. Furthermore, the technicians may not be the best suited to perform the subsequent jobs, and therefore, as a further consequence, the entity may have to expend further computing resources to remedy any issues that may arise from the job being performed by the new technicians.

Accordingly, it is desirable to have a system that accurately predicts different metrics associated with a particular job to be able to appropriately assign the jobs. By appropriately assigning the jobs based on accurate estimates, the entity may be able to conserve computing resources that may otherwise be unnecessarily expended to address issues arising from inaccurate estimates.

In some implementations described herein, a system may be provided to accurately predict values (e.g., time and/or cost) associated with completion of a job based on historical data. To do so, the system may determine dynamic cluster arrangements of clusters of technicians to perform the job. The dynamic cluster arrangements may be formed based on such factors as the type of job, location of the job (e.g., distance of the cluster arrangements from the location of the job), the particular time of year (e.g., month and/or season), day of the week, and/or time of day. Based on exogenous factors associated with the cluster arrangements (e.g., number of clusters and/or associated geographic locations) and/or associated with the job (e.g., weather-related factors), the system may be able to accurately determine forecast values corresponding to endogenous factors associated with the job. The forecast values may be determined using a rule-based system, a machine learning model, and/or historical data with respect to the dynamic cluster arrangements. Based on the accurate forecast values, the system is able to select one of the cluster arrangements, and assign the job to technicians associated with the selected cluster arrangement. Accordingly, by accurately predicting the forecast values and therefore most efficiently assigning technicians to complete the job, the system is able to efficiently utilize its computing resources and time to appropriately assign jobs and save resources that may otherwise be expended to correct jobs that were not accurately assigned and/or correct scheduling issues that may arise as a result.

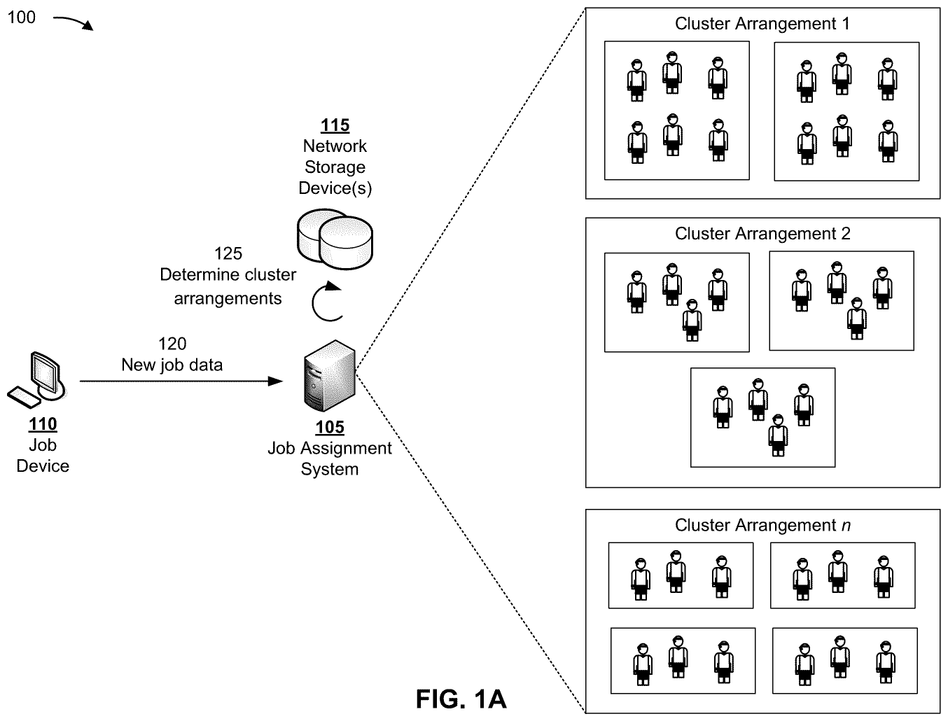

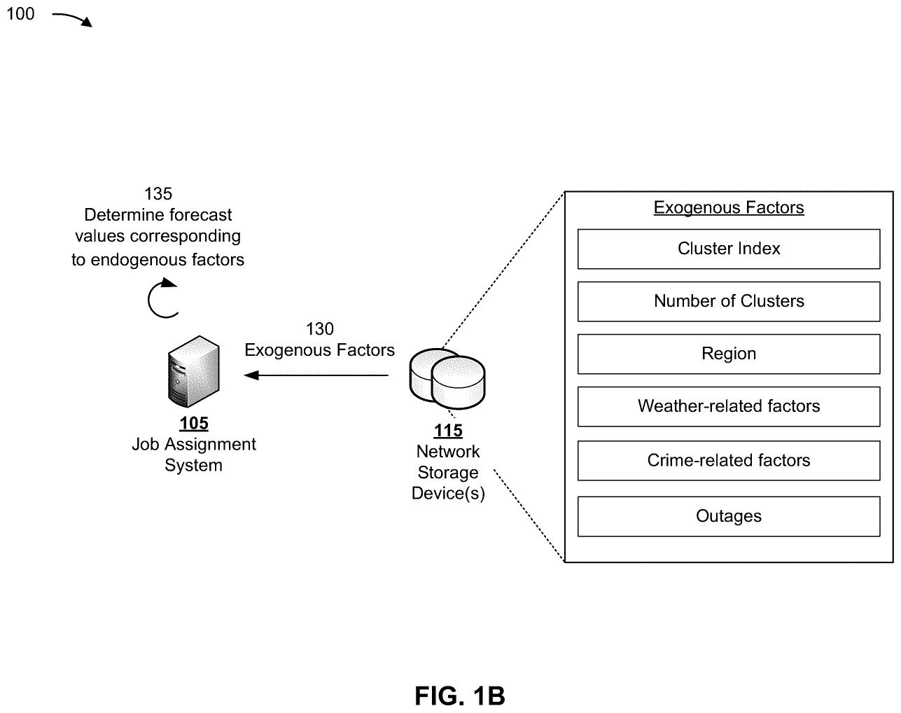

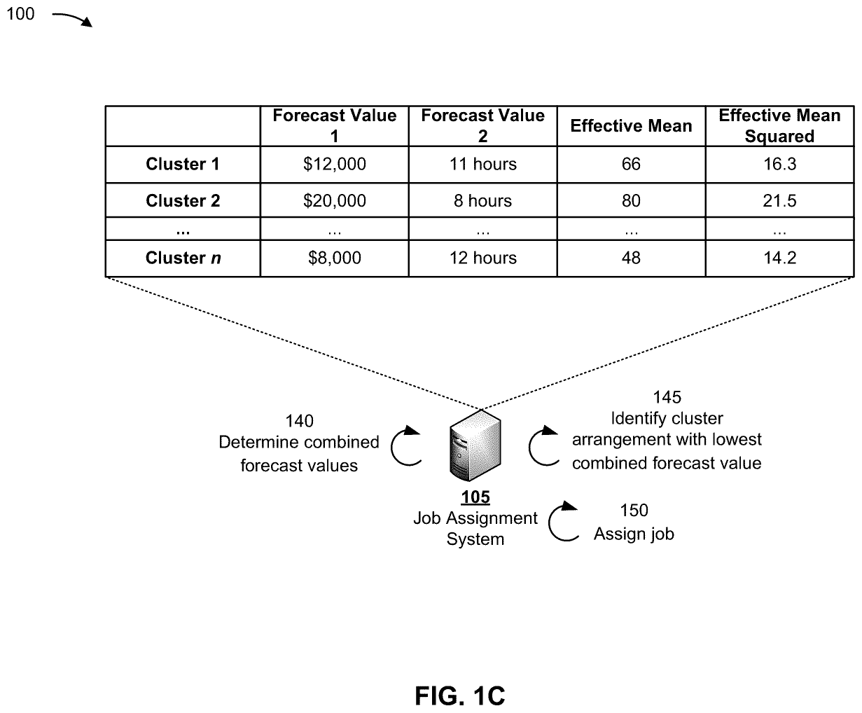

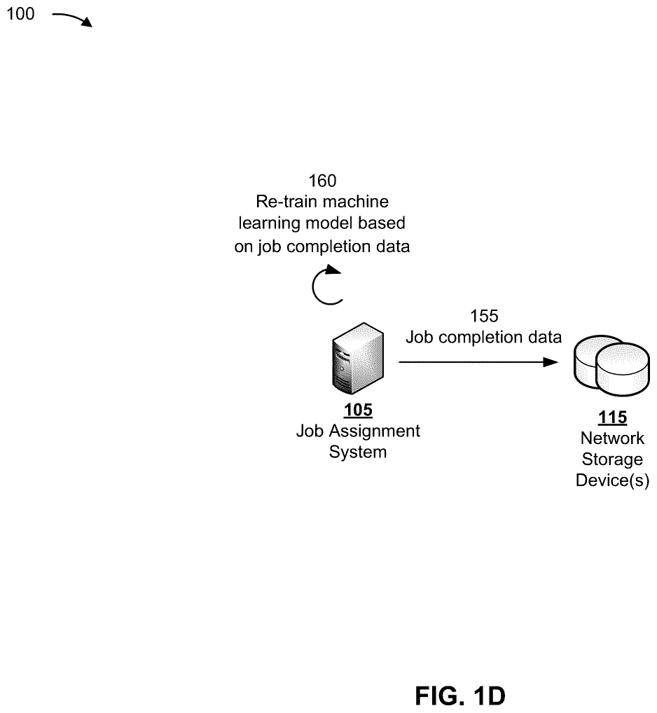

FIGS. 1A-1D are diagrams of an example 100 associated with job assignment based on dynamic clustering. As shown in FIGS. 1A-1D, example 100 includes a job assignment system 105, a job device 110, and one or more network storage devices 115. As shown in FIGS. 1A-1D, the job assignment system 105 may assign a particular job to one or more technicians from a particular cluster of technicians.

As shown in FIG. 1A, and by reference number 120, the job assignment system 105 may receive, from a job device 110, data corresponding to a new job (also referred to as “new job data”) that needs to be assigned (e.g., to one or more technicians). For example, the job may be associated with a trouble ticket generated based on an issue a user (e.g., a customer or client) may be having with a particular device (e.g., a set top box, a router, or the like). As another example, the job may be associated with a service outage, damage to equipment (e.g., a network tower, cable line, or the like), and/or failure of equipment that may affect multiple users in a particular geographic area. The job device 110 may be a device of a user or of a contact center (e.g., a call center) addressing issues of the user and/or issuing the trouble tickets. The job data may indicate details associated with the job, such as a type of job (e.g., router issue, service outage, equipment damage, or equipment failure) and/or a geographic region (e.g., zip code or service area) associated with the job.

As shown by reference number 125, the job assignment system 105 may determine a plurality of cluster arrangements associated with the job. A particular cluster arrangement may include multiple clusters. The clusters may be of any group that may need to be shared and/or assigned across multiple tasks. For example, a cluster may be composed of a group of technicians that can perform a particular job. The technicians may be in the same location (e.g., from the same service office or garage). As another example, a cluster may be based on a group of registered devices. A particular cluster arrangement may be associated with one or more characteristics, such as a cluster index (e.g., an identification number), by which the cluster arrangement may be identified, a geographic location (e.g., a coverage zone or a zip code), cluster sizes of the clusters, a number of points (e.g., technicians and/or devices) within the clusters, distance between the clusters of the cluster arrangement, or the like. The cluster arrangements may vary by one or more of the characteristics. For example, a first cluster arrangement (e.g., Cluster Arrangement 1 in FIG. 1A) may have a first number of clusters (e.g., 2) each with a first number of technicians (e.g., 6). A second cluster arrangement (e.g., Cluster Arrangement 2 in FIG. 1A) may have a second number of clusters (e.g., 3) each with a second number of technicians (e.g., 4). A third cluster arrangement (e.g., Cluster Arrangement n) may have a third number of clusters (e.g., 4) each with a third number of technicians (e.g., 3). There may be any number of cluster arrangements, any number of clusters in a particular cluster arrangement, and/or any number of technicians in a particular cluster. Clusters within the same cluster arrangement may have the same number of technicians or may have different number of technicians.

In some implementations, the job assignment system 105 may determine the plurality of cluster arrangements based on one or more characteristics associated with the job and historical data (e.g., historical cluster data) associated with the characteristic(s), which may be obtained from a network storage device 115. For example, the job assignment system 105 may identify one or more characteristics associated with the job, such as a day (e.g., a specific day of the week and/or a designation of a weekday or a weekend), a week, a month, a time of year (e.g., a particular season), a job type, a number of hours associated with the job type (e.g., an average number of hours, a minimum number of hours, and/or a maximum number of hours), a cost associated with the job type (e.g., an average cost, a minimum cost, and/or a maximum cost) and/or a location of the job (e.g., zip code, geographic coordinates, and/or a distance radius from the geographic coordinates). The job assignment system 105 may identify the characteristic(s) from new job data.

Additionally, the job assignment system 105 may obtain historical cluster data based on the characteristic(s), historical cluster data. In some implementations, the historical cluster data may indicate one or more characteristics associated with the historical cluster arrangements, such as a cluster index (e.g., an identification number), by which the cluster arrangement may be identified, a geographic location (e.g., a coverage zone or a zip code), cluster sizes of the clusters, a number of points (e.g., technicians and/or devices) within the clusters, distance between the clusters of the cluster arrangement, or the like. the historical cluster data may correspond to historical cluster arrangements formed for previous jobs having same or similar (e.g., within threshold values) characteristics associated with the job to be assigned.

The job assignment system 105 may form the cluster arrangements based on the historical cluster data. For example, the job assignment system 105 may form the cluster arrangements based on similarly configured cluster arrangements (e.g., number of clusters and/or number of technicians) for a same or similar job type in a different geographic region, for a different job type in a similar geographic region (e.g., the same geographic region, an overlapping geographic region, or a geographic region having similar geographic characteristics, such as weather, terrain, population, or population density), or the same or similar job type and geographic region. Additionally, or alternatively, the job assignment system 105 may form the cluster arrangements based on a same or similar time period associated with the job. For example, if the time period is in the summer, on a weekday, and in the morning, the job assignment system 105 may form cluster arrangements based on historical data of historical jobs associated with a similar time period. As a result, the job assignment system 105 may be able to dynamically form the cluster arrangements in a precise manner that may be most appropriate for the particular job to be assigned.

As shown in FIG. 1B, and by reference number 130, the job assignment system 105 may determine which of the cluster arrangements to use to assign the job based on exogenous factors. Exogenous factors are external factors, such as factors related to the cluster arrangements (e.g., cluster index, number of clusters, and/or region associated with a particular cluster arrangement) and/or factors related to the particular job (e.g., weather-related factors, such as temperature and wind speed, associated with the geographic region, crime-related factors, such as riots, theft, and/or damage, associated with the geographic region, and/or planned outages (e.g., for maintenance) associated with equipment in the geographic region). The job assignment system 105 may obtain data corresponding to the exogenous factors from one or more network storage devices 115, which may be the same or may be separate from the network storage device 115 from which the job assignment system 105 obtained historical cluster data to determine the cluster arrangements. The data may be obtained over a time threshold (e.g., the previous month, three months, six months, or year).

In some implementations, the job assignment system 105 may use a model to determine which of the cluster arrangements to use to assign the job, where values corresponding to the exogenous factors may be used as inputs to the model. For example, the model may be a forecasting model, such as seasonal auto-regressive integrated moving average with exogenous factors job assignment (SARIMAX) or auto-regressive integrated moving average with exogenous factors (ARIMAX). Additionally, or alternatively, the model may be a machine learning model, which may be trained based on historical data (e.g., historical job data) associated with historical jobs.

As shown by reference number 135, based on the values corresponding to the exogenous factors, the job assignment system 105 may determine forecast values corresponding to one or more endogenous factors. Endogenous factors are time-related factors associated with the particular job. As an example, in a scenario in which a trouble ticket has been generated, the endogenous factors may include a time associated with completing the job and/or a cost associated with completing the job. For a particular cluster arrangement, these endogenous factors may be dependent upon exogenous factors that include the cluster index associated with the cluster arrangement, the number of clusters within the cluster arrangement, and/or the geographic location associated with the cluster arrangement. As another example, in a scenario in which the job is related to a service outage, failure of equipment, and/or damage to equipment, the endogenous factors may include a minimum outage time associated with the service outage and/or a minimum time to restore or repair the equipment. For a particular cluster arrangement, these endogenous factors may be dependent upon exogenous factors associated the cluster arrangement (e.g., cluster index, number of clusters, and/or geographic location) and/or weather-related factors (e.g., temperature and/or wind speed) associated with the geographic region of the job.

In implementations in which a model (e.g., a machine learning model) is used, the values corresponding to the exogenous factors (also referred to as input values) may be inputs to the model. Additionally, the forecast values corresponding to the endogenous factors may be the outputs of the model.

As shown in FIG. 1C, the job assignment system 105 may select one of the cluster arrangements (also referred to as the selected cluster arrangement), from which one or more technicians may be assigned the job. The selected cluster arrangement may be based on the forecast values associated with the selected cluster arrangement. For example, the job assignment system 105 may compare the forecast values associated with all of the cluster arrangements, and the job assignment system 105 may select the selected cluster arrangement if the associated forecast values satisfy a condition. If only one endogenous factor is associated with the particular job (e.g., cost to complete the job or time to complete the job), then the condition may be that the forecast value corresponding to the endogenous factor is the lowest. Depending on the corresponding endogenous factor, other exemplary conditions may be that the forecast value is the highest, within a percentage threshold of the highest forecast value, or within a percentage threshold of the lowest forecast value.

If multiple endogenous factors are associated with the particular job (e.g., cost to complete the job and time to complete the job), then the condition may be based on a combination of the corresponding forecast values (also referred to as a combined forecast value). For example, as shown by reference number 140, the job assignment system 105 may determine combined forecast values corresponding to the different cluster arrangements. In some implementations, the combined forecast value for a particular cluster arrangement may be a weighted average of the forecast values for the particular cluster arrangement (e.g., an effective mean and/or an effective mean squared). Then, as shown by reference number 145, the job assignment system 105 may identify the cluster arrangement having the lowest combined forecast values (or other satisfied condition), and select that cluster arrangement as the selected cluster arrangement. It should be appreciated that the values shown in FIG. 1C are only provided as an example and are not intended to be limiting in any way.

As shown by reference number 150, the job assignment system 105 may assign the job based on the selected cluster arrangement. For example, the job assignment system 105 may assign the job to one or more technicians and/or the technicians from a particular cluster associated with the selected cluster arrangement.

As shown in FIG. 1D, and by reference number 155, after completion of the job, the job assignment system 105 may store job completion data (e.g., actual values associated with the completion of the job) as historical job data, such as in a network storage device 115, which may be the same as the network storage device 115 on which the historical job data may be stored. Accordingly, the actual values may be used for future determinations of forecast values. As shown by reference number 160, in implementations in which a machine learning model is used to determine the forecast values, the job assignment system 105 may re-train the machine learning model based on the job completion data (e.g., the actual values associated with the completion of the job).

As described above, the job assignment system is able to utilize historical data associated with jobs, together with external (e.g., exogenous) factors associated with the jobs, to accurately predict forecast values associated with job-specific endogenous factors for future jobs. By accurately predicting these values, the job assignment system is able to efficiently utilize its computing resources and time to appropriately assign jobs. Additionally, the job assignment system is able to conserve computing resources that may otherwise be unnecessarily expended to address issues arising from inaccurate estimates, such as rescheduling jobs and/or re-assigning technicians.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

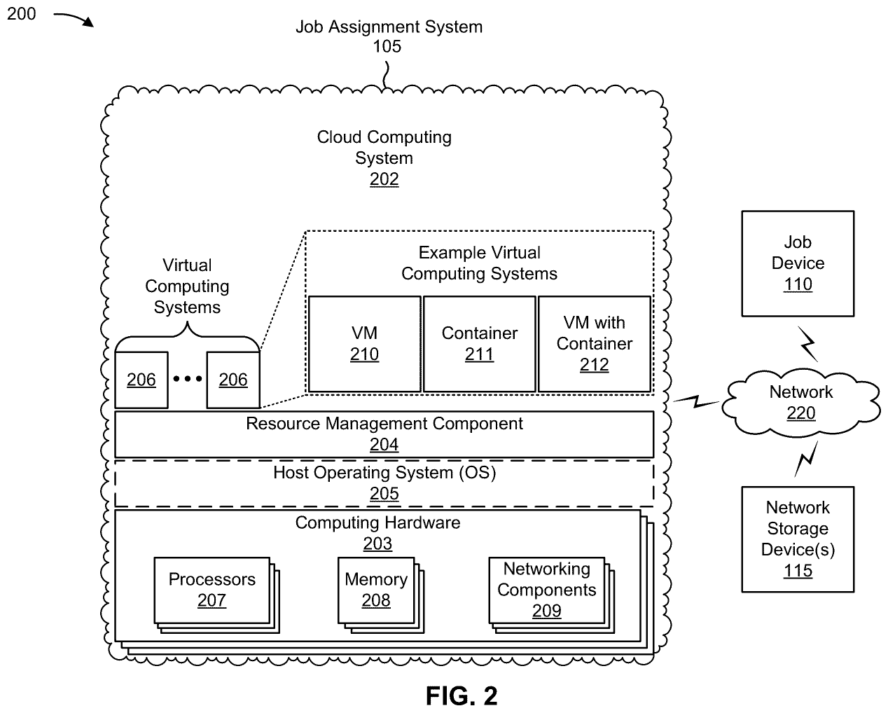

FIG. 2 is a diagram of an example environment 200 in which systems and/or methods described herein may be implemented. As shown in FIG. 2, environment 200 may include a job assignment system 105, which may include one or more elements of and/or may execute within a cloud computing system 202. The cloud computing system 202 may include one or more elements 203-212, as described in more detail below. As further shown in FIG. 2, environment 200 may include a job device 110, one or more network storage devices 115, and/or a network 220. Devices and/or elements of environment 200 may interconnect via wired connections and/or wireless connections.

The job device 110 may include one or more devices capable of receiving, generating, storing, processing, and/or providing information associated with job assignment based on dynamic clustering, as described elsewhere herein. The job device 110 may include a communication device and/or a computing device. For example, the job device 110 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network storage device(s) 115 may include one or more devices capable of receiving, generating, storing, processing, and/or providing information associated with job assignment based on dynamic clustering, as described elsewhere herein. The network storage device(s) 115 may include a communication device and/or a computing device. For example, the network storage device(s) 115 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the network storage device(s) 115 may store historical data, such as historical cluster data, which may correspond to historical clusters associated with particular jobs and/or geographic regions, and/or historical job data, which may indicate historical values corresponding to exogenous factors and/or endogenous factors associated with historical jobs correspond to historical jobs, as described elsewhere herein.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

Computing hardware 203 includes hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 includes a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 includes a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

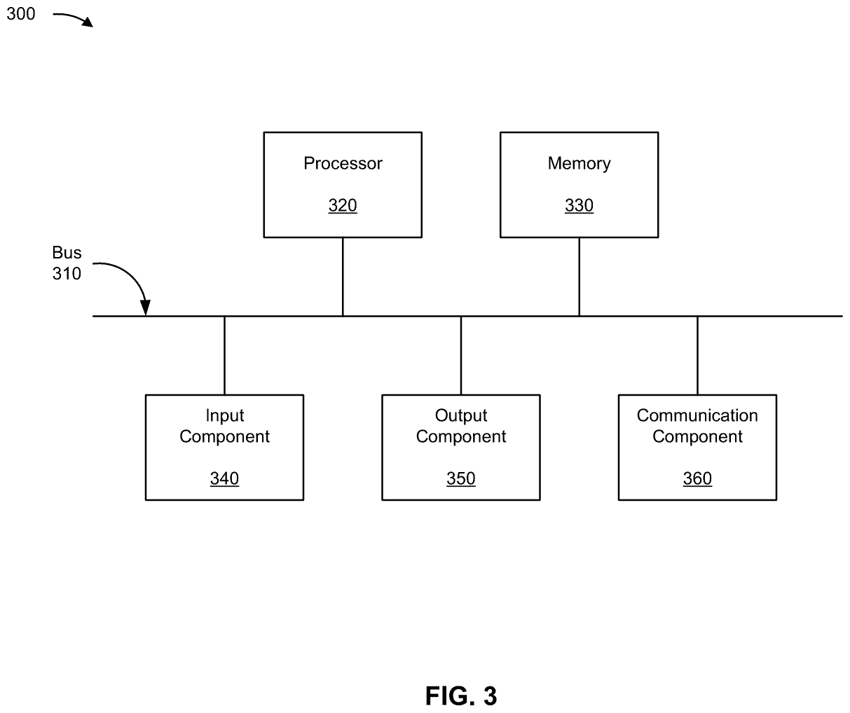

Although the job assignment system 105 201 may include one or more elements 203-212 of the cloud computing system 202, may execute within the cloud computing system 202, and/or may be hosted within the cloud computing system 202, in some implementations, the job assignment system 105 201 may not be cloud-based (e.g., may be implemented outside of a cloud computing system) or may be partially cloud-based. For example, the job assignment system 105 201 may include one or more devices that are not part of the cloud computing system 202, such as device 300 of FIG. 3, which may include a standalone server or another type of computing device. The job assignment system 105 201 may perform one or more operations and/or processes described in more detail elsewhere herein.

Network 220 includes one or more wired and/or wireless networks. For example, network 220 may include a cellular network, a public land mobile network (PLMN), a local area network (LAN), a wide area network (WAN), a private network, the Internet, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with job assignment. Device 300 may correspond to the job assignment system 105, the job device 110, and/or the network storage device(s) 115. In some implementations, the job assignment system 105, the job device 110, and/or the network storage device(s) 115 may include one or more devices 300 and/or one or more components of device 300. As shown in FIG. 3, device 300 may include a bus 310, a processor 320, a memory 330, an input component 340, an output component 350, and a communication component 360.

Bus 310 may include one or more components that enable wired and/or wireless communication among the components of device 300. Bus 310 may couple together two or more components of FIG. 3, such as via operative coupling, communicative coupling, electronic coupling, and/or electric coupling. Processor 320 may include a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 may include one or more processors capable of being programmed to perform one or more operations or processes described elsewhere herein.

Memory 330 may include volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 may include one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

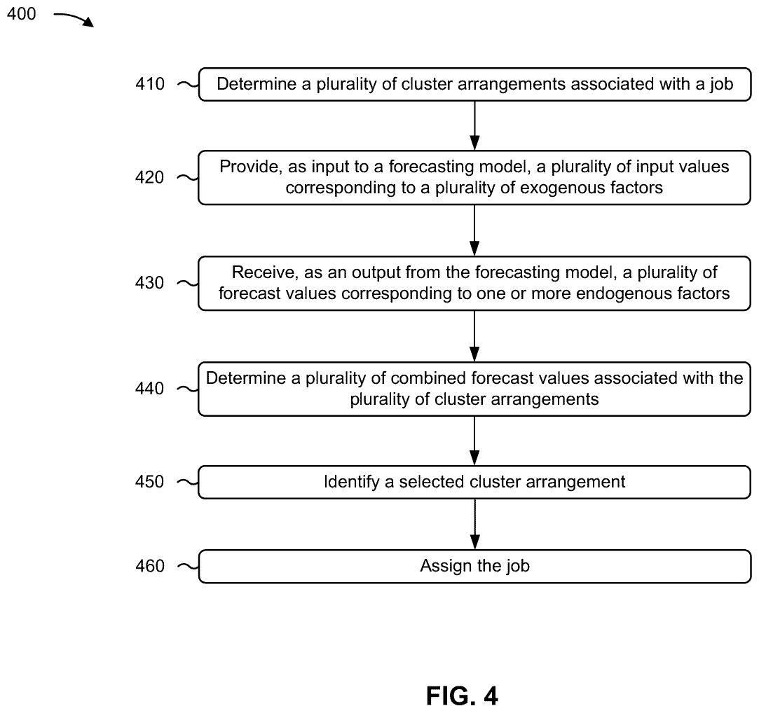

FIG. 4 is a flowchart of an example process 400 associated with job assignment based on dynamic clustering. In some implementations, one or more process blocks of FIG. 4 may be performed by a device (e.g., job assignment system 105). In some implementations, one or more process blocks of FIG. 4 may be performed by one or more components of device 300, such as processor 320, memory 330, input component 340, output component 350, and/or communication component 360.

As shown in FIG. 4, process 400 may include determining a plurality of cluster arrangements associated with a job to be performed (block 410). For example, the device may determine a plurality of cluster arrangements, as described above. In some implementations, a particular cluster arrangement, of the plurality of cluster arrangements, may include a plurality of clusters of technicians to perform the job.

In some implementations, the device may determine and form the plurality of cluster arrangements based on one or more factors related to one or more characteristics associated with the job. Exemplary factors may include a job type, a time of the year (e.g., a month and/or a season), a day of the week (e.g., a specific day, a weekday, or a weekend), and/or a time of day (e.g., a specific time frame, morning, afternoon, or evening). In some implementations, the device may determine and form the plurality of cluster arrangements based on historical data associated with historical jobs having one or more characteristics the same or similar to the one or more characteristics associated with the job.

As further shown in FIG. 4, process 400 may include providing, as input to a model, a plurality of input values corresponding to a plurality of exogenous factors (block 420). For example, the device may provide, as input to a model, a plurality of input values corresponding to a plurality of exogenous factors associated with the job and with the plurality of clusters, as described above.

In some implementations, the plurality of input values may correspond to one or more characteristics associated with the job. For example, the input values may correspond to a job type, a time of the year (e.g., a month and/or a season), a day of the week (e.g., a specific day, a weekday, or a weekend), and/or a time of day (e.g., a specific time frame, morning, afternoon, or evening) associated with the job.

In some implementations, the one or more exogenous factors may include one or more weather-related factors associated with a geographic region associated with the job. In some implementations, the one or more weather-related factors may include a temperature associated with the geographic region or a wind speed associated with the geographic region.

In some implementations, the model may be a forecasting model. In some implementations, the model may be a machine learning model trained using historical job data associated with a plurality of historical jobs. In some implementations, the historical job data may indicate historical values corresponding to the plurality of exogenous factors and the one or more endogenous factors associated with the plurality of historical jobs. In some implementations, process 400 may include re-training the machine learning model based on actual values corresponding to the one or more endogenous factors associated with a completion of the job by the one or more technicians associated with the selected cluster arrangement.

As further shown in FIG. 4, process 400 may include receiving, as an output from the model, a plurality of forecast values corresponding to one or more endogenous factors (block 430). For example, the device may receive, as an output from the forecasting model, a plurality of forecast values corresponding to one or more endogenous factors associated with the plurality of cluster arrangements, as described above.

In some implementations, the one or more endogenous factors may include a plurality of endogenous factors. In some implementations, the combined forecast value associated with the particular cluster arrangement may be a weighted average of endogenous factor values corresponding to the plurality of endogenous factors associated with the particular cluster arrangement.

In some implementations, the one or more endogenous factors may include a number of hours associated with a completion of the job and a cost associated with the completion of the job. In some implementations, the job may be associated with one or more of a service outage, damage to equipment, or failure of the equipment, and the one or more endogenous factors may include one or more of a minimum outage time associated with the service outage, or a minimum time to restore the equipment.

As further shown in FIG. 4, process 400 may include determining a plurality of combined forecast values associated with the plurality of cluster arrangements (block 440). For example, the device may determine a plurality of combined forecast values associated with the plurality of cluster arrangements, as described above. In some implementations, a combined forecast value, of the plurality of combined forecast values, associated with a particular cluster arrangement, of the plurality of cluster arrangements, may be a combination of one or more forecast values, of the plurality of forecast values, corresponding to the one or more endogenous factors associated with the particular cluster arrangement.

As further shown in FIG. 4, process 400 may include identifying a selected cluster arrangement (block 450). For example, the device may identify a selected cluster arrangement, of the plurality of clusters, having a lowest combined forecast value of the plurality of combined forecast values, as described above.

As further shown in FIG. 4, process 400 may include assigning the job (block 460). For example, the device may assign the job to one or more technicians associated with the selected cluster arrangement, as described above.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

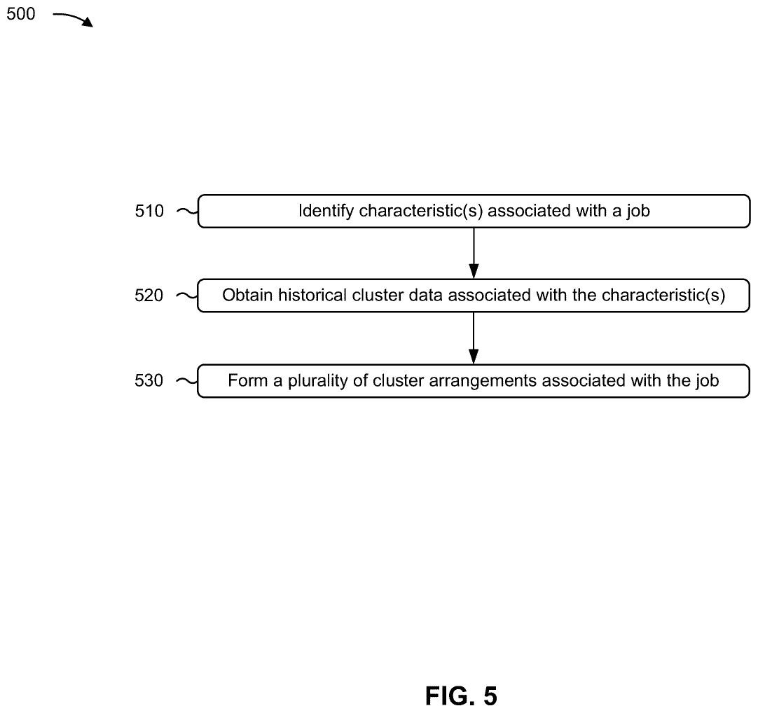

FIG. 5 is a flowchart of an example process 500 associated with job assignment based on dynamic clustering. In some implementations, one or more process blocks of FIG. 5 may be performed by a device (e.g., job assignment system 105). In some implementations, one or more process blocks of FIG. 5 may be performed by one or more components of device 300, such as processor 320, memory 330, input component 340, output component 350, and/or communication component 360.

As shown in FIG. 5, process 500 may include identifying characteristic(s) associated with a job (block 510). For example, the device may identify one or more characteristics associated with the job, as described above. In some implementations, the characteristic(s) may include a day (e.g., a specific day of the week and/or a designation of a weekday or a weekend), a week, a month, and/or a time of year (e.g., a particular season). Additionally, or alternatively, the characteristic(s) may include a job type, a number of hours associated with the job type (e.g., an average number of hours, a minimum number of hours, and/or a maximum number of hours), a cost associated with the job type (e.g., an average cost, a minimum cost, and/or a maximum cost) and/or a location of the job (e.g., zip code, geographic coordinates, and/or a distance radius from the geographic coordinates).

As further shown in FIG. 5, process 500 may include obtaining historical cluster data based on the characteristic(s) (block 520). For example, the device may obtain, based on the characteristic(s), historical cluster data of historical cluster arrangements associated with the characteristic(s), as described above. In some implementations, the historical cluster data may indicate one or more characteristics associated with the historical cluster arrangements, such as a cluster index (e.g., an identification number), by which the cluster arrangement may be identified, a geographic location (e.g., a coverage zone or a zip code), cluster sizes of the clusters, a number of points (e.g., technicians and/or devices) within the clusters, distance between the clusters of the cluster arrangement, or the like.

As further shown in FIG. 5, process 500 may include forming a plurality of cluster arrangements associated with the job (block 530). For example, the device may form, based on the historical cluster data, a plurality of cluster arrangements associated with the job, as described above.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
determining, by a device, a plurality of cluster arrangements associated with a job to be performed,
wherein a particular cluster arrangement, of the plurality of cluster arrangements, includes a plurality of clusters of technicians to perform the job;
providing, by the device and as input to a model, a plurality of input values corresponding to a plurality of exogenous factors associated with the job and with the plurality of cluster arrangements,
receiving, by the device and as an output from the model, a plurality of forecast values corresponding to one or more endogenous factors associated with the plurality of cluster arrangements;
determining, by the device, a plurality of combined forecast values associated with the plurality of cluster arrangements,
wherein a combined forecast value, of the plurality of combined forecast values, associated with a particular cluster arrangement, of the plurality of cluster arrangements, is a combination of one or more forecast values, of the plurality of forecast values, corresponding to the one or more endogenous factors associated with the particular cluster arrangement;
identifying, by the device, a selected cluster arrangement, of the plurality of cluster arrangements, having a lowest combined forecast value of the plurality of combined forecast values; and.
assigning, by the device, the job to one or more technicians associated with the selected cluster arrangement.

2. The method of claim 1, wherein the model is a machine learning model trained using historical job data associated with a plurality of historical jobs, and
wherein the historical job data indicates historical values corresponding to the plurality of exogenous factors and the one or more endogenous factors associated with the plurality of historical jobs.

3. The method of claim 2, further comprising:
re-training the machine learning model based on actual values corresponding to the one or more endogenous factors associated with a completion of the job by the one or more technicians associated with the selected cluster arrangement.

4. The method of claim 1, wherein the one or more endogenous factors include a plurality of endogenous factors, and
wherein the combined forecast value associated with the particular cluster arrangement is a weighted average of endogenous factor values corresponding to the plurality of endogenous factors associated with the particular cluster arrangement.

5. The method of claim 1, wherein the one or more endogenous factors include a number of hours associated with a completion of the job and a cost associated with the completion of the job.

6. The method of claim 1, wherein the job is associated with one or more of a service outage, damage to equipment, or failure of the equipment, and
wherein the one or more endogenous factors include one or more of:
a minimum outage time associated with the service outage, or
a minimum time to restore the equipment.

7. The method of claim 1, wherein the plurality of exogenous factors include one or more weather-related factors associated with a geographic region associated with the job, and
wherein the one or more weather-related factors include at least one of a temperature or a wind speed associated with the geographic region.

8. The method of claim 1, wherein the model is a forecasting model.

9. A device, comprising:
one or more processors configured to:
determine a plurality of cluster arrangements associated with a job to be performed,
wherein a particular cluster arrangement, of the plurality of cluster arrangements, is associated with a cluster index by which the particular cluster arrangement is identifiable, a geographic location, and a number of clusters in the particular cluster arrangement;
determine, based on set values corresponding to a plurality of exogenous factors associated with the job and with the plurality of cluster arrangements, a plurality of forecast values corresponding to a plurality of endogenous factors;
determine a plurality of combined forecast values associated with the plurality of cluster arrangements,
wherein a combined forecast value, of the plurality of combined forecast values, associated with a particular cluster arrangement, of the plurality of cluster arrangements, is a weighted average of forecast values, of the plurality of forecast values, corresponding to the plurality of endogenous factors associated with the particular cluster arrangement;
identify a selected cluster arrangement, of the plurality of cluster arrangements, having a lowest combined forecast value of the plurality of combined forecast values; and
assign the job to one or more technicians associated with the selected cluster arrangement.

10. The device of claim 9, wherein the one or more processors, when determining the plurality of forecast values, are configured to:
use a machine learning model to determine the plurality of forecast values,
wherein the machine learning model is trained using historical job data associated with a plurality of historical jobs, and
wherein the historical job data indicates historical values corresponding to the plurality of exogenous factors and the plurality of endogenous factors associated with the plurality of historical jobs; and
re-training the machine learning model based on actual values corresponding to the plurality of endogenous factors associated with a completion of the job by the one or more technicians.

11. The device of claim 9, wherein the plurality of exogenous factors includes a number of clusters, of the plurality of clusters, associated with a particular cluster arrangement of the plurality of cluster arrangements.

12. The device of claim 9, wherein the plurality of exogenous factors includes one or more of a temperature or a wind speed associated with a geographic region associated with the job.

13. The device of claim 12, wherein the plurality of endogenous factors includes a number of hours associated with a completion of the job and a cost associated with the completion of the job.

14. The device of claim 9, wherein two or more cluster arrangements, of the plurality of cluster arrangements, differ in one or more of the number of clusters or the geographic location associated with the two or more cluster arrangements.

15. A non-transitory computer-readable medium storing a set of instructions, the set of instructions comprising:
one or more instructions that, when executed by one or more processors of a device, cause the device to:
determine a plurality of cluster arrangements associated with a job to be performed,
wherein a particular cluster arrangement, of the plurality of cluster arrangements, is associated with a cluster index by which the particular cluster arrangement is identifiable, a geographic location, and a number of clusters in the particular cluster arrangement;
determine, based on set values corresponding to a plurality of exogenous factors associated with the job and with the plurality of cluster arrangements, a plurality of forecast values corresponding to a plurality of endogenous factors;
determine a plurality of combined forecast values associated with the plurality of cluster arrangements,
wherein a combined forecast value, of the plurality of combined forecast values, associated with a particular cluster arrangement, of the plurality of cluster arrangements, is a weighted average of forecast values, of the plurality of forecast values, corresponding to the plurality of endogenous factors associated with the particular cluster arrangement; and
identify a selected cluster arrangement, of the plurality of cluster arrangements, having a lowest combined forecast value of the plurality of combined forecast values.

16. The non-transitory computer-readable medium of claim 15, wherein the one or more instructions, that cause the device to determine the plurality of clusters, cause the device to:
determine the plurality of cluster arrangements based on historical cluster data associated with one or more of a job type associated with the job or a geographic region associated with the job.

17. The non-transitory computer-readable medium of claim 15, wherein the plurality of endogenous factors includes a number of hours associated with a completion of the job and a cost associated with the completion of the job.

18. The non-transitory computer-readable medium of claim 15, wherein the job is associated with one or more of a service outage, damage to equipment, or failure of equipment, and
wherein the plurality of endogenous factors includes one or more of:
a minimum outage time associated with the service outage, or
a minimum time to restore the equipment.

19. The non-transitory computer-readable medium of claim 18, wherein the plurality of exogenous factors includes one or more weather-related factors associated with a geographic region associated with the job.

20. The non-transitory computer-readable medium of claim 19, wherein the one or more weather-related factors include a temperature associated with the geographic region or a wind speed associated with the geographic region.
